(19) United States
(12) Patent Application Publication
(10) Pub. No.: US 2008/0257976 A1
(43) Pub. Date: Oct. 23, 2008

(54) Nozzle for industrial processing

(76) Inventor: Wolfgang Danzer, Dorfen (DE)

Correspondence Address: The BOC Group, Inc., 575 MOUNTAIN AVENUE, MURRAY HILL, NJ, 07974-2082, US

(21) Appl. No.: 11/903,786

(22) Filed: Sep. 25, 2007

(30) Foreign Application Priority Data
Oct. 24, 2006 (DE) 102006050059.8
Dec. 19, 2006 (EP) 06026335.7

(51) Int. Cl. B05B 1/24

(52) U.S. Cl. 239/13; 239/128

(57) ABSTRACT

A nozzle with at least one central nozzle channel through which at least one jet intended for flame, for laser beam and/or for the arc welding and at least one gas flow can be guided, wherein the contour of the nozzle channel has two curves which merge into each other directly or via an intermediate straight, of which curves the in direction of the gas flow first curve seen from the central axis of the nozzle channel extending in direction of the gas flow is curved in a concave manner and the direction of the gas flow second curve seen from the central axis of the nozzle channel is curved in a convex manner, so that the gas flow flows out of the gas outlet within at least one wide pressure range in a laminar manner and without pressure relaxation even on changing of the gas pressure.

### BACKGROUND OF THE INVENTION

The present invention relates to a nozzle with at least one central nozzle channel through which at least one jet intended for a flame method, for a laser beam method and/or for arc welding and at least one gas flow can be guided, wherein the contour of the nozzle channel has two curves merging into each other directly or via an intermediate straight, of which curves the in the direction of the gas flow first curve seen from the direction of the central axis of the nozzle channel extending in the direction of the gas flow is curved in a concave manner and the in the direction of the gas flow second curve seen from the central axis of the nozzle channel is curved in a convex manner.

A gas nozzle for the feeding of gas, more preferably of at least one protective gas or at least one cutting gas, to its place of usage during cutting or during welding is for instance known from the publication DE 20 2004 011 430 U1.

When using gases in processing materials a fundamental technical problem is how efficiently and with which method the gas is brought to the process location. For example the gas during welding should cover the welding location as thoroughly as possible and during cutting the gas should deliberately drive the melted material from the cut groove via the effect of force.

In the process it is attempted to employ the ideal nozzle in each case for the respective application. During flame cutting for example different nozzle shapes are employed to achieve optimum efficiency of the gas feed. The main objective here is that the cutting gas leaves the cutting nozzle at different pressures and flow rates free of turbulences, in a laminar and cylindrical manner.

A gas nozzle for protective gas welding is known for example from the publication DD-PS 133 537. This known gas nozzle has a ring-shaped distribution channel to achieve a homogenous gas flow.

For laser beam welding or for laser beam cutting a gas nozzle tapering in the direction of the gas outlet is known from the publication DE 40 16 200 A1.

In addition, using a so-called Laval nozzle for laser beam welding or for laser beam cutting is known from the publications EP 0 458 180 A2, EP 1 018 394 A2 and JP 56136295 A. The cross section of the Laval nozzle initially narrows and again widens as far as the gas outlet through which a gas flowing through can be accelerated to hypersonic speed without severe compression shocks occurring.

A gas nozzle with at least one central nozzle channel through which at least one jet and at least one gas flow can be guided, is known from the publication DE 689 06 429 T2. The cross section of this gas nozzle again widens at the gas outlet similar to that in a Laval nozzle.

Normally, the above mentioned nozzles are not optimised or not matched to the application required in each case. Consequently an increase of the gas pressure with the gas nozzles described above results in that the gas does not flow out from the nozzle in a laminar way but escapes sideways at the gas outlet where it leads to turbulences.

### SUMMARY OF THE INVENTION

Based on the disadvantages and shortcomings explained above and appreciating the outlined prior art the present invention is based on the object of further developing a nozzle of the type mentioned at the outset so that the gas flow flows out of the gas outlet in a laminar way and almost without any pressure relaxation even if the gas pressure is changed within at least one wide pressure range, more preferably that the nozzle can be employed over wide pressure ranges with different applications.

This object is solved through a nozzle with the a nozzle with at least one central nozzle channel through which at least one jet intended for a flame method, for a laser beam method and/or for the arc welding and at least one gas flow can be guided, wherein the contour of the nozzle channel has two curves which merge with each other directly or via an intermediate straight, of which curves the in direction of the gas flow first curve seen from the central axis of the nozzle channel extending in the direction of the gas flow is curved in a concave manner and the in direction of the gas flow second curve seen from the central axis of the nozzle channel is curved in a convex manner, characterized in that the nozzle channel has its smallest diameter at the gas flow outlet. Advantageous designs and suitable further developments of the present invention are further characterized below.

Thus, the present invention is based on a fluid-mechanical optimisation of the nozzle shape, more preferably on the provision of a wind tunnel nozzle for use in material processing.

With the nozzle shape according to the present invention the gas pressure upstream of the nozzle for example from at least one gas bottle or from at least one tank is substantially completely converted into laminar kinetic energy. As a result, a better gas-dynamic effect in the cut groove during cutting and a better coverage effect during welding are achieved.

In contrast with conventional gas nozzles the gas with the nozzle according to the present invention on exiting the nozzle is not expanded, fanned out or swirled due to static pressure.

The fact that when using the fluid-mechanically optimised nozzle according to the present invention it is possible to work over wide application ranges with the same nozzle shape, i.e. with one nozzle type, is rated a further advantageous distinguishing criterion of the present invention relative to the prior art.

Supplying the nozzle with different or more preferably any gas pressures is possible for the nozzle according to the present invention on increasing the gas pressure the gas flows out from the gas outlet faster and the gas outlet flow remains laminar at the same time. Thus, by means of the nozzle according to the present invention different or more preferably high velocities of the laminar gas outlet flow can be achieved.

With regard to the advantages realised through the present invention it must be noted in addition that when using identical gas rates with the nozzle according to the present invention, higher efficiencies or higher quality and productivity compared with conventional nozzles are obtained.

According to an advantageous further development of the present invention the more preferably ring-shaped nozzle channel is preferentially subdivided by means of at least one ring gap,
into at least one first, more preferably outer nozzle channel relative to the central axis and
into at least one second, more preferably inner nozzle channel relative to the central axis.

Here it is possible to guide at least one first gas flow through the first nozzle channel and at least one second gas flow through the second nozzle channel. The gas flow guided through the nozzle can for example consist of at least one auxiliary cutting gas and/or at least one protective gas. Compressed air can also be employed.

When using a ring gap nozzle the first gas flow can support the second gas flow and amplify its positive effects. In addition, by using
a first gas flow, such as an inner ring gap gas and
a second gas flow chemically and/or physically different from the first gas flow, for instance an outer ring gap gas, specific effects can be created.

The present invention further relates to a laminar gas flow provided by means of at least one nozzle according to the type presented above.

Finally the present invention relates to the use of at least one nozzle of the type presented above and/or at least one laminar gas flow of the type presented above
with at least one flame method, more preferably
with flame cutting, for example with flame hardening, with flame brazing, with flame straightening, with flame blasting, with flame heating, with groove planing and/or with gas welding, and/or
with thermal spraying, for example with flame spraying, as for instance with high-speed flame spraying, with cold gas spraying, with arc spraying and/or with plasma spraying, and/or
with at least one laser beam method, more preferably with laser brazing, with laser cutting, such as with laser melt cutting, with laser welding and/or with laser spraying, and/or
with arc joining, more preferably with arc brazing, with arc welding, with plasma cutting and/or with plasma welding, for example with Metal Active Gas (MAG) welding, with Metal Inert Gas (MIG) welding or with Tungsten Inert Gas (TIG) welding.

The nozzle of the type presented above and/or the laminar gas flow of the type presented above can also be used with additional flame methods not explicitly mentioned above.

### BRIEF DESCRIPTION OF THE DRAWINGS

As already discussed above there are different possibilities of designing and further developing the teaching of the present invention in an advantageous manner. To this end further designs, characteristics and advantages of the present invention are explained in more detail by means of the exemplary embodiment illustrated through FIG. 1A and FIG. 2.

FIG. 1A is a perspective representation an exemplary embodiment of a nozzle according to the present invention.

FIG. 1B is a sectional representation a nozzle according to the prior art.

FIG. 2 is a schematic representation the contour of the nozzle of FIG. 1A, wherein the radius of the nozzle channel is represented as a function of the respective point on the central axis.

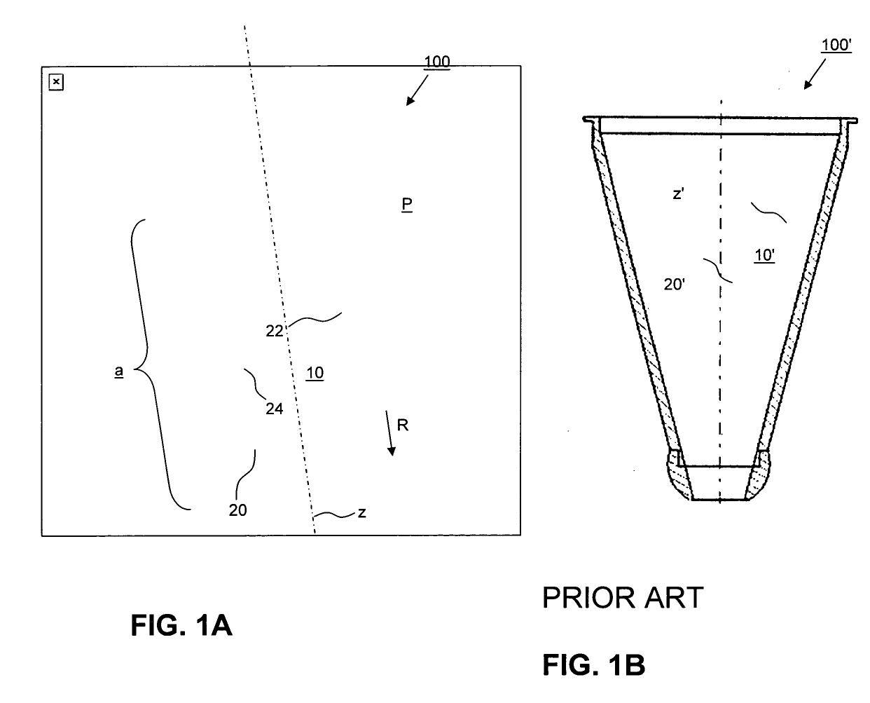

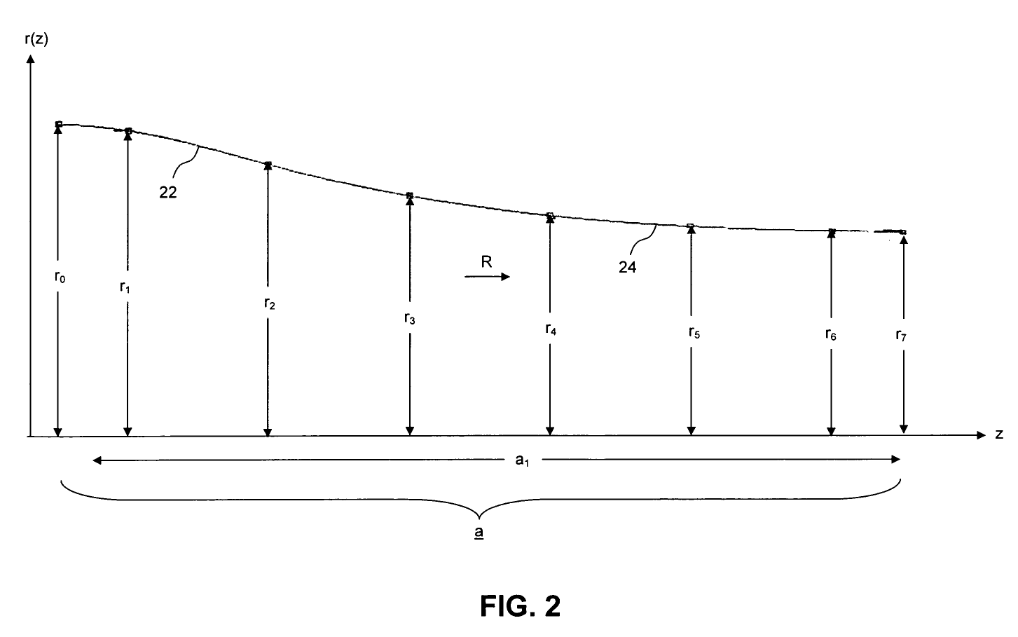

Same or similar designs, elements or characteristics are provided with identical reference numbers in FIG. 1A to FIG. 2.

### DETAILED DESCRIPTION OF THE INVENTION

The exemplary embodiment of the present invention illustrated by means of FIG. 1A and FIG. 2, shows a nozzle 100 with a central nozzle channel 10 through which at least one jet intended for a flame method, for a laser beam method and/or for the arc joining and at least one gas flow can be guided.

The nozzle channel 10 tapers in the direction R of the gas flow over the entire length a and thus has its smallest diameter 2·r₇ at the gas flow outlet. The starting diameter 2·r₀ of the nozzle channel 10 at the gas flow inlet is thus larger than the end diameter 2·r₇ of the nozzle channel 10 at the gas flow outlet, wherein the end radius r₇ is the smallest radius of the nozzle channel 10.

The exemplary embodiment of a nozzle 100 according to the present invention shown in FIG. 1A differs from the nozzle 100′ from the state of the art presented in FIG. 1B through the respective contour 20 of the nozzle channel 10, wherein the nozzle 100 shown in FIG. 1A has two curves 22, 24 which directly merge into each other.

Of these curves 22, 24, the in the direction R of the gas flow first curve 22 seen from the central axis z of the nozzle channel 10 extending in the direction R of the gas flow is curved in a concave manner and the in the direction R of the gas flow second curve 24 seen from the central axis z of the nozzle channel 10 is curved in a convex manner.

Here, the extent of the first curve 22 along the central axis z is less than the extent of the second curve 24 along the central axis z.

The radius r(z) of the nozzle channel 10 in the region of the central axis z has a defined relationship relative to the starting radius r0 of the nozzle channel 10, relative to the length a of the nozzle channel 10 extending along the central axis z and relative to the end radius r₇ of the nozzle channel 10. More preferably the radius r(z) of the nozzle channel 10 in the region of the central axis z can be calculated by means of the so-called Witoszynski formula which reads as follows:

r(z)=r₀·[1−(1−r₀²/r₇²)·(1−3z²/a²)²·(1+z²/a²)⁻³]^{-1/2}

With this formula nozzle contours are obtained which make it possible that the respective gas is able to leave the nozzle in a laminar manner and without static pressure relaxation. The laminar outflow of the gas is shown, wherein the gas flow was rendered visible by means of smoke. The nozzle can be found in the figure at the top and the work piece at the bottom. In between the laminar gas flow rendered visible through smoke is visible, wherein the smoke makes the photography appear blurred. Merely on impinging of the laminar gas flow on the work piece is a widening of the gas flow visible, otherwise no turbulences whatsoever or deviations of the gas flow from the flow direction are detectable.

The contour of the nozzle obtained from the Witoszynski formula is shown in FIG. 2, wherein the radii r₀, r₁, r₂, r₃, r₄, r₅, r₆, r₇ are represented at regular distances of approximately twenty millimetres of the nozzle channel 10.

For example
the starting radius r₀ of the nozzle channel is approximately 35 millimetres,
the first radius r₁ in flow direction R between starting radius r₀ and end radius r₇ of the nozzle channel is approximately 34.11 millimetres,
the second radius r₂ in flow direction R between starting radius r₀ and end radius r₇ of the nozzle channel is approximately 29.32 millimetres,
the third radius r₃ in flow direction R between starting radius r₀ and end radius r₇ of the nozzle channel is approximately 24.14 millimetres,
the fourth radius r₄ in flow direction R between starting radius r₀ and end radius r₇ of the nozzle channel is approximately 22.166 millimetres,
the fifth radius r₅ in flow direction R between starting radius r₀ and end radius r₇ of the nozzle channel is approximately 20.687 millimetres,
the sixth radius r₆ in flow direction R between starting radius r₀ and end radius r₇ of the nozzle channel is approximately 20.066 millimetres and
the end radius r₇ of the nozzle channel is approximately twenty millimetres.

The nozzle 100 from FIG. 1A is attached to a plate P. This plate however is neither a necessary nor an obligatory part of the nozzle 100. The length a₁ measured along the central axis z or longitudinal extent of the nozzle channel 10 from the gas flow outlet to the plate P is approximately 110 millimetres.

### LIST OF REFERENCE NUMBERS

100 Nozzle, more preferably wind tunnel nozzle, according to the present invention (refer FIG. 1A, FIG. 2)
100′ Nozzle according to the prior art (refer FIG. 1B)
10 Nozzle channel of the nozzle 100 according to the present invention (refer FIG. 1A, FIG. 2)
10′ Nozzle channel of the nozzle 100′ according to the prior art (refer FIG. 1B)
20 Contour of the nozzle channel 10 according to the present invention (refer FIG. 1A, FIG. 2)
20′ Contour of the nozzle channel 10′ according to the prior art (refer FIG. 1B)
22 First concave curve of the contour 20 of the nozzle channel 10
24 Second convex curve of the contour 20 of the nozzle channel 10
a Length or longitudinal extent of the nozzle channel 10 measured along the central axis z
a₁ Length measured along the central axis z or longitudinal extent of the nozzle channel 10 from the plate P to the gas outlet
P Plate
r Radius of the nozzle channel 10
r₀ Starting radius of the nozzle channel 10
r₁ In flow direction R first radius between starting radius r₀ and end radius r₇ of the nozzle channel 10
r₂ In flow direction R second radius between starting radius r₀ and end radius r₇ of the nozzle channel 10
r₃ In flow direction R third radius between starting radius r₀ and end radius r₇ of the nozzle channel 10
r₄ In flow direction R fourth radius between starting radius r₀ and end radius r₇ of the nozzle channel 10
r₅ In flow direction R fifth radius between starting radius r₀ and end radius r₇ of the nozzle channel 10
r₆ In flow direction R sixth radius between starting radius r₀ and end radius r₇ of the nozzle channel 10
r₇ End radius of the nozzle channel 10
r(z) Radius of the nozzle channel 10 at a point z of the central axis between starting radius r₀ and end radius r₇
R Direction of the gas flow or flow direction
z Central axis of the nozzle channel 10 according to the present invention (refer FIG. 1A, FIG. 2)
z′ Central axis of the nozzle channel 10′ according to the prior art (refer FIG. 1B)

What I claim is:

1. A nozzle with at least one central nozzle channel through which at least one jet and at least one gas flow can be guided, wherein the contour of the nozzle channel has two curves which merge with each other directly or via an intermediate straight, of which curves the in direction of the gas flow first curve seen from the central axis of the nozzle channel extending in the direction of the gas flow is curved in a concave manner and the in direction of the gas flow second curve seen from the central axis of the nozzle channel is curved in a convex manner, characterized in that the nozzle channel has its smallest diameter at the gas flow outlet.

2. The nozzle according to claim 1, characterized in that said at least one jet is selected from the group of flame, laser beam and arc welding.

3. The nozzle according to claim 1, characterized in that the nozzle channel is ring-shaped or tapers over the entire length in direction of the gas flow.

4. The nozzle according to claim 3, characterized in that the starting radius of the nozzle channel at the gas flow inlet is larger than the end radius of the nozzle channel at the gas flow outlet and the end radius is the smallest radius of the nozzle channel.

5. The nozzle according to claim 1, characterized in that the extent of the first curve along the central axis is smaller than the extent of the second curve along the central axis.

6. The nozzle according to claim 1, characterized in that the radius of the nozzle channel in the region of the central axis is in a defined relationship to the length of the nozzle channel extending along the central axis, to the starting radius of the nozzle channel and to the end radius of the nozzle channel.

7. The nozzle according to claim 6, characterized in that the radius of the nozzle channel in the region of the central axis can be calculated by means of the formula r(z)=r₀·[1−(1−r₀²/r₇²)·(1−3z²/a²)²·(1+z²/a²)⁻³]^{-1/2}.

8. The nozzle according to claim 1, characterized in that the nozzle channel, preferentially by means of at least one ring gap is subdivided, into at least one first more preferably with regard to the central axis outer nozzle channel and into at least one second, more preferably with regard to the central axis inner nozzle channel.

9. The nozzle according to claim 8, characterized in that the gas flow has at least one first gas flow and at least one second gas flow, wherein the first gas flow can be guided through the first nozzle channel and the second gas flow through the second nozzle channel.

10. The nozzle according to claim 1, characterized in that the gas flow consists of at least one auxiliary cutting gas and/or of at least one protective gas.

11. A laminar gas flow, provided by means of at least one nozzle according to claim 1.

12. A method of using a nozzle with at least one central nozzle channel through which at least one jet and at least one gas flow can be guided, wherein the contour of the nozzle channel has two curves which merge with each other directly or via an intermediate straight, of which curves the in direction of the gas flow first curve seen from the central axis of the nozzle channel extending in the direction of the gas flow is curved in a concave manner and the in direction of the gas flow second curve seen from the central axis of the nozzle channel is curved in a convex manner, characterized in that the nozzle channel has its smallest diameter at the gas flow outlet, wherein said at least one jet is selected from the group consisting of flame, laser beam and arc welding.

13. The method according to claim 12 wherein said laser beam welding is selected from the group consisting of laser welding, laser cutting and laser soldering.

14. The method according to claim 12, wherein said flame welding is selected from the group consisting of flame cutting and thermal spraying.

15. The method according to claim 12, wherein said arc welding is selected from the group consisting of arc blazing, arc joining, plasma cutting and plasma welding.
